(19) United States
(12) Patent Application Publication
(10) Pub. No.: US 2009/0258274 A1
(43) Pub. Date: Oct. 15, 2009

(54) MEMBRANE ELECTRODE ASSEMBLY AND FUEL CELLS OF INCREASED POWER

(75) Inventors: Oemer Uensal, Mainz (DE); Thomas Schmidt, Mörfelden-Walldorf (DE); Mathias Weber, Rüsselsheim (DE)

Correspondence Address: CONNOLLY BOVE LODGE & HUTZ, LLP, P O BOX 2207, WILMINGTON, DE, 19899, US

(73) Assignee: BASF Fuel Cell GmbH, Frankfurt Am Main (DE)

(21) Appl. No.: 12/375,550

(22) PCT Filed: Jul. 31, 2007
(86) PCT No.: PCT/EP07/06741

§ 371 Date: Jan. 29, 2009

(30) Foreign Application Priority Data
Aug. 2, 2006 (DE) 10 2006 036 019.2

(51) Int. Cl. H01M 8/10; H01M 4/82

(52) U.S. Cl. 429/33; 429/30; 29/623.1; 29/623.5

(57) ABSTRACT

A membrane electrode assembly, comprising at least two electrochemically active electrodes which are separated by at least on polymer electrolyte membrane, wherein the polymer electrolyte membrane has reinforcing elements which penetrate the polymer electrolyte membrane at least partially.

The membrane electrode assembly is preferably obtained by a method in which
(i) a polymer electrolyte membrane is formed in the presence of the reinforcing elements,
(ii) the membrane and the electrodes are assembled in the desired order.

The membrane electrode assembly is particularly suited for applications in fuel cells.

The present invention relates to membrane electrode assemblies and fuel cells with increased performance which comprise at least two electrochemically active electrodes which are separated by a polymer electrolyte membrane.

Polymer electrolyte membrane (PEM) fuel cells are already known. Currently, sulphonic acid-modified polymers are almost exclusively used in these fuel cells as proton-conducting membranes. Here, predominantly perfluorinated polymers are used. Nation™ from DuPont de Nemours, Wilmington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen, usually restricts the operating temperature of the PEM fuel cell stacks to 80-100° C. When applying pressure, the operating temperatures can be increased to >120° C. Otherwise, higher operating temperatures can not be realised without a loss of power in the fuel cell.

Due to system-specific reasons, however, operating temperatures in the fuel cell of more than 100° C. are desirable. The activity of the catalysts based on noble metals and contained in the membrane electrode assembly (MEA) is significantly improved at high operating temperatures. When the so-called reformates from hydrocarbons are used, the reformer gas in particular contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system via combined power and heat generation can be increased.

To achieve these temperatures, in general, membranes with new conductivity mechanisms are used. One approach to this end is the use of membranes which show electrical conductivity without employing water. The first promising development in this direction is set forth in document WO 96/13872.

As the tappable voltage of an individual fuel cell is relatively low, in general, several membrane electrode assemblies are connected in series and connected to each other via planar separator plates (bipolar plates). In doing so, the membrane electrode assemblies and the separator plates have to be compressed with each other under relatively high pressures to achieve a system tightness as good as possible, a performance as high as possible and a volume as low as possible.

However, in practice, the compression of the membrane electrode assemblies with the separator plates often results in problems as the polymer electrolyte membranes used have a relatively low mechanical strength and stability and therefore can be easily damaged during the compression.

Due to the required high compression of the polymer electrolyte membrane on the one hand and its low mechanical stability on the other, reproducible results can furthermore only be achieved with difficulty. In most cases, the performance of the resulting fuel cell stacks varies heavily which is brought about by more or less pronounced cracks in the individual membranes and/or by varying compression forces being applied to the membranes.

Therefore, the object of the present invention was to provide membrane electrode assemblies and fuel cells with a performance as high as possible which can be produced in a manner as simple as possible, on a large scale, as inexpensive as possible and reproducible, if possible.

In this connection, the fuel cells should preferably have the following properties:
The fuel cells should have a service life as long as possible.
It should be possible to employ the fuel cells at operating temperatures as high as possible, in particular above 100° C.
In operation, the individual cells should exhibit a constant or improved performance over a period, which should be as long as possible.
After a long operating time, the fuel cells should have an open circuit voltage as high as possible as well as a gas crossover as low as possible. Furthermore, it should be possible to operate them with a stoichiometry as low as possible.
The fuel cells should manage to do without additional humidification of the fuel gas, if possible.
The fuel cells should be able to withstand permanent or alternate pressure differences between anode and cathodes as good as possible.
In particular, the fuel cells should be robust to different operating conditions (T, p, geometry, etc.) to increase the general reliability as good as possible.
Furthermore, the fuel cells should have an improved temperature and corrosion resistance and a relatively low gas permeability, in particular at high temperatures. A decline of the mechanical stability and the structural integrity, in particular at high temperatures, should be avoided as good as possible.

These objects are solved by an individual fuel cell with all the features of claim 1.

Accordingly, the object of the present invention is a membrane electrode assembly which comprises at least two electrochemically active electrodes which are separated by at least one polymer electrolyte membrane, and wherein the above-mentioned polymer electrolyte membrane has reinforcing elements which penetrate the polymer electrolyte membrane at least partially.

For the purposes of the present invention, suitable polymer electrolyte membranes are known per se and are in principle not subject to any limitations. In fact, any proton-conducting material is suitable. However, membranes comprising acids are preferably employed wherein the acids may be covalently bound to polymers. Furthermore, a flat material may be doped with an acid in order to form a suitable membrane. Additionally, gels, in particular polymer gels can also be used as the membrane, polymer membranes particularly suited for the present purposes being described in DE 102 464 61, for example.

These membranes can, amongst other methods, be produced by swelling flat materials, for example a polymer film, with a fluid comprising aciduous compounds, or by manufacturing a mixture of polymers and aciduous compounds and the subsequent formation of a membrane by forming a flat structure and following solidification in order to form a membrane.

The polymers suitable for this purpose include, amongst others, polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene (PTFE), polyhexafluoropropylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example, polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethyleneterephthalate, polybutyleneterephthalate, polyhydroxybenzoate, polyhydroxypropionic acid, polypivalolacton, polycaprolacton, polymalonic acid, polycarbonate;
polymers having C—S bonds in the main chain, for example polysulphide ether, polyphenylene sulphide, polysulphones, polyethersulphone;
polymers having C—N bonds in the backbone, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid-crystalline polymers, in particular Vectra™, and
inorganic polymers, for example polysilanes, polycarbosilanes, polysiloxanes, polysilicic acid, polysilicates, silicones, polyphosphazenes and polythiazyl.

Preferred herein are alkaline polymers, wherein this particularly applies to membranes containing acids or doped with acids, respectively. Almost all known polymer membranes in which protons can be transported come into consideration as such alkaline polymer membranes. Here, acids are preferred which are able to transport the protons without additional water, for example by means of the so-called Grotthus mechanism.

As alkaline polymer within the context of the present invention, an alkaline polymer with at least one nitrogen, oxygen or sulphur atom, preferably at least one nitrogen atom in a repeating unit is preferably used. Furthermore, alkaline polymers comprising at least one heteroaryl group are preferred.

According to a preferred embodiment, the repeating unit in the alkaline polymer contains an aromatic ring with at least one nitrogen atom. The aromatic ring is preferably a five-membered or six-membered ring with one to three nitrogen atoms, which may be fused to another ring, in particular another aromatic ring.

According to one particular aspect of the present invention, use is made of high-temperature-stable polymers which contain at least one nitrogen, oxygen and/or sulphur atom in one or in different repeating units.

Within the context of the present invention, stable at high temperatures means a polymer which can be operated over the long term as a polymeric electrolyte in a fuel cell at temperatures above 120° C. Over the long term means that a membrane according to the invention can be operated for at least 100 hours, preferably at least 500 hours, at a temperature of at least 80° C., preferably at least 120° C., particularly preferably at least 160° C., without the performance being decreased by more than 50%, based on the initial performance, which can be measured according to the method described in WO 01/18894A2.

Within the scope of the present invention, all of the above-mentioned polymers can be employed individually or as a mixture (blend). Here, preference is given in particular to blends which contain polyazoles and/or polysulphones. In this context, the preferred blend components are polyethersulphone, polyether ketone and polymers modified with sulphonic acid groups, as described in the German patent applications DE 100 522 42 and DE 102 464 61.

Furthermore, for the purposes of the present invention, polymer blends comprising at least one alkaline polymer and at least one acidic polymer, preferably in a weight ratio of 1:99 to 99:1 (so-called acid-base polymer blends) have also proven to be advantageous. In this connection, particularly suitable acidic polymers comprise polymers containing sulphonic acid and/or phosphonic acid groups. Acid-base polymer blends that are very particularly suited according to the invention are described in detail in document EP 1073690 A1, for example.

Polyazoles constitute a particularly preferred group of alkaline polymers. An alkaline polymer based on polyazole contains recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

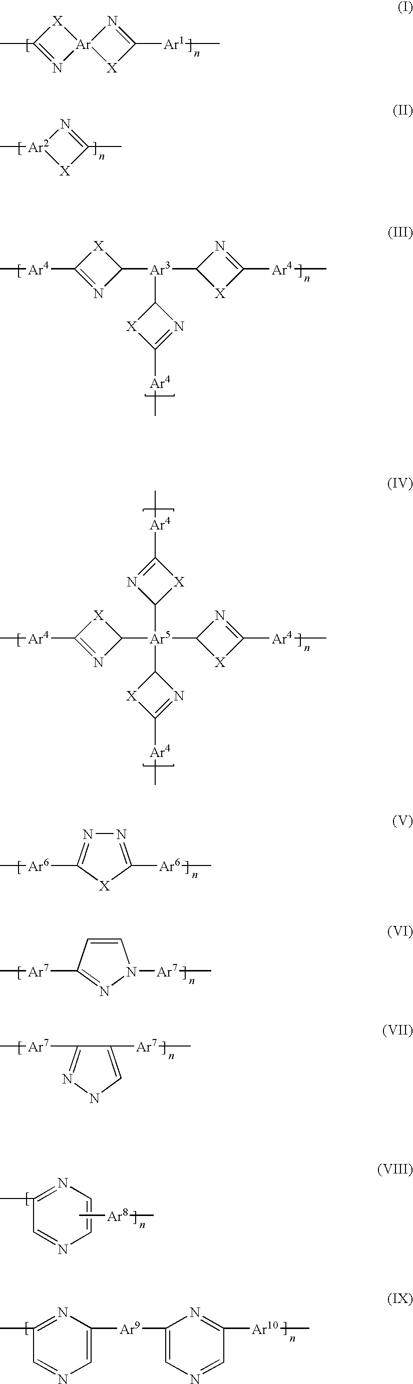

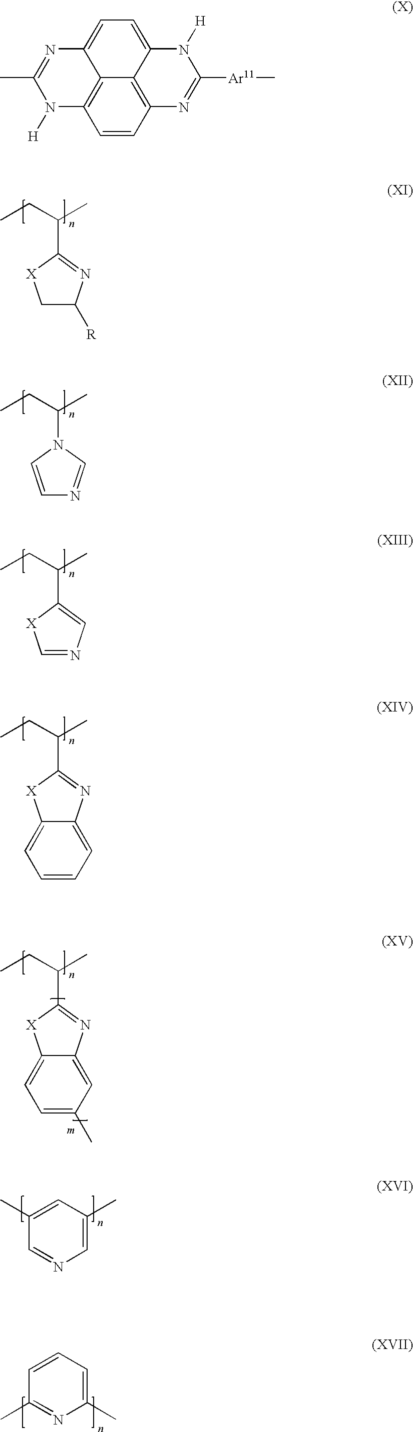

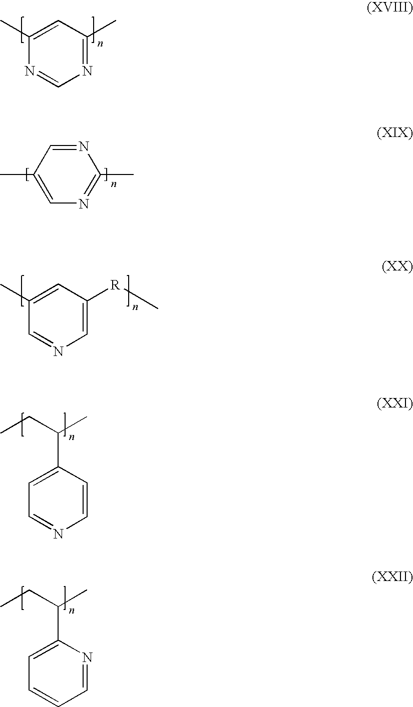

wherein
Ar are identical or different and represent a tetravalent aromatic or heteroaromatic group which can be mononuclear or polynuclear,
Ar¹ are identical or different and represent a divalent aromatic or heteroaromatic group which can be mononuclear or polynuclear,
Ar² are identical or different and represent a divalent or trivalent aromatic or heteroaromatic group which can be mononuclear or polynuclear,
Ar³ are identical or different and represent a trivalent aromatic or heteroaromatic group which can be mononuclear or polynuclear,
Ar⁴ are identical or different and represent a trivalent aromatic or heteroaromatic group which can be mononuclear or polynuclear,
Ar⁶ are identical or different and represent a tetravalent aromatic or heteroaromatic group which can be mononuclear or polynuclear,
Ar⁶ are identical or different and represent a divalent aromatic or heteroaromatic group which can be mononuclear or polynuclear,
Ar⁷ are identical or different and represent a divalent aromatic or heteroaromatic group which can be mononuclear or polynuclear,
Ar⁸ are identical or different and represent a trivalent aromatic or heteroaromatic group which can be mononuclear or polynuclear,
Ar⁹ are identical or different and represent a divalent or trivalent or tetravalent aromatic or heteroaromatic group which can be mononuclear or polynuclear,
Ar¹⁰ are identical or different and represent a divalent or trivalent aromatic or heteroaromatic group which can be mononuclear or polynuclear,
Ar¹¹ are identical or different and represent a divalent aromatic or heteroaromatic group which can be mononuclear or polynuclear,
X are identical or different and represent oxygen, sulphur or an amino group which carries a hydrogen atom, a group having 1-20 carbon atoms, preferably a branched or unbranched alkyl or alkoxy group, or an aryl group as a further radical,
R are identical or different and represent hydrogen, an alkyl group or an aromatic group and in formula (XX) an alkylene group or an aromatic group, with the proviso that R in formula (XX) is not hydrogen, and
n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene which may also be substituted.

Preferred alkyl groups are short-chain alkyl groups having from 1 to 4 carbon atoms, such as, e.g., methyl, ethyl, n-propyl or i-propyl and t-butyl groups.

Preferred aromatic groups are phenyl or naphthyl groups. The alkyl groups and the aromatic groups may be substituted.

Preferred substituents are halogen atoms, e.g. fluorine, amino groups, hydroxy groups or short-chain alkyl groups, e.g. methyl or ethyl groups.

Preference is given to polyazoles having recurring units of the formula (I) in which the radicals X within a recurring unit are identical.

The polyazoles can in principle also have different recurring units wherein their radicals X are different, for example. However, there are preferably only identical radicals X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole, which only contains units of the formulae (I) and/or (II).

The number of recurring azole units in the polymer is preferably an integer greater than or equal to 10. Particularly preferred polymers contain at least 100 recurring azole units.

Within the context of the present invention, preference is given to polymers containing recurring benzimidazole units. Some examples of the most appropriate polymers containing recurring benzimidazole units are represented by the following formulae:

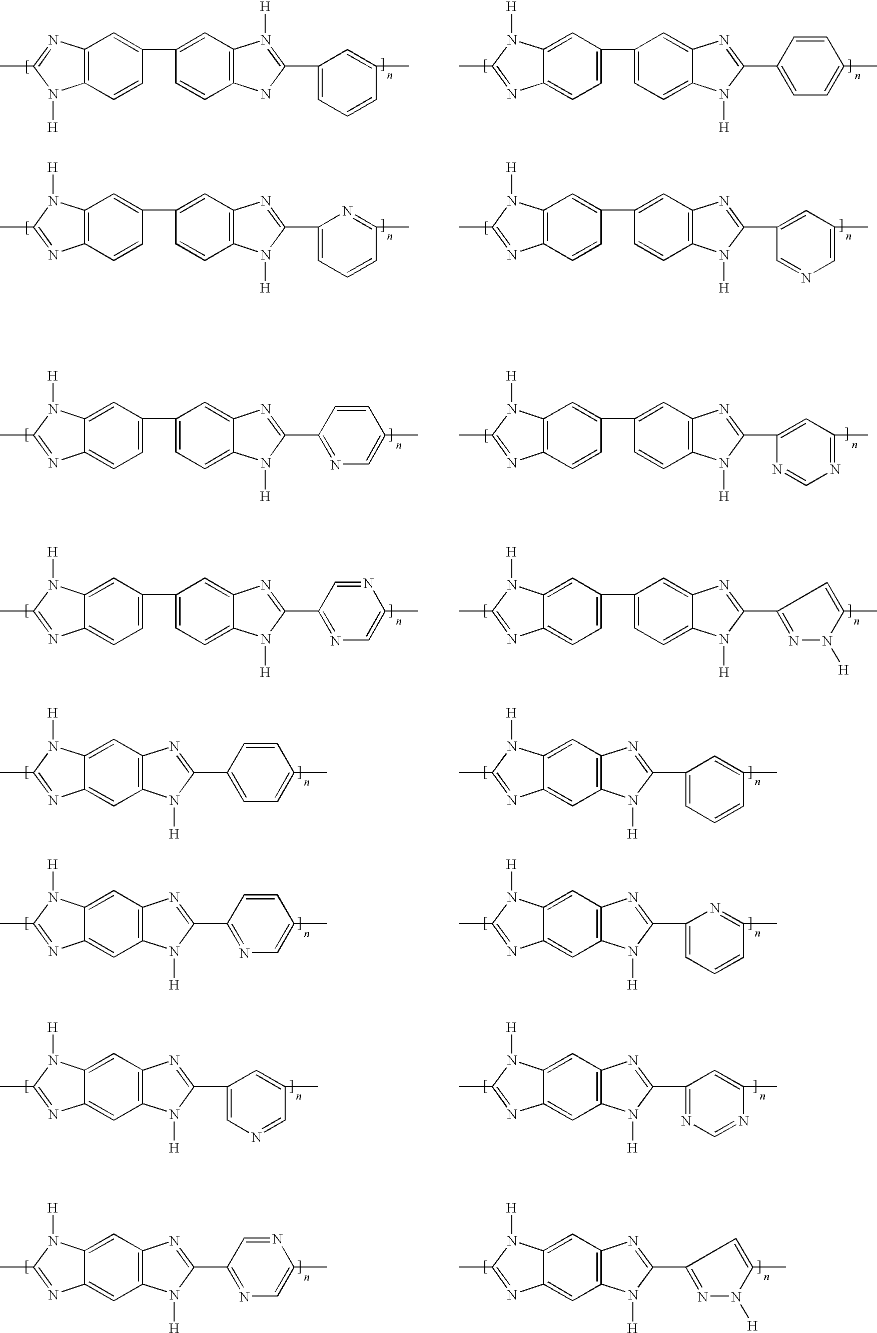

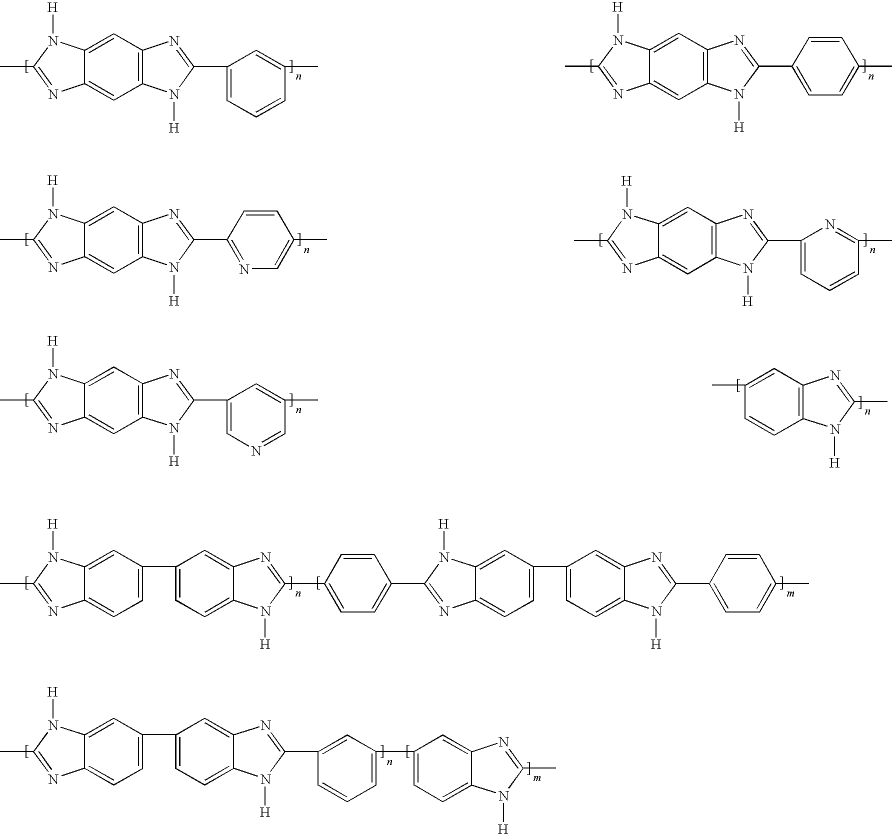

where n and m are integers greater than or equal to 10, preferably greater than or equal to 100.

The polyazoles used, in particular, however, the polybenzimidazoles are characterized by a high molecular weight. Measured as the intrinsic viscosity, this is preferably at least 0.2 dl/g, preferably 0.8 to 10 dl/g, in particular 1 to 10 dl/g.

Preferred polybenzimidazoles are commercially available under the trade name Celazole®.

Preferred polymers include polysulphones, in particular polysulphone having aromatic and/or heteroaromatic groups in the backbone. According to one particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured according to ISO 1133. Here, preference is given to polysulphones with a Vicat softening temperature VST/A/50 of 180° C. to 230° C. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F

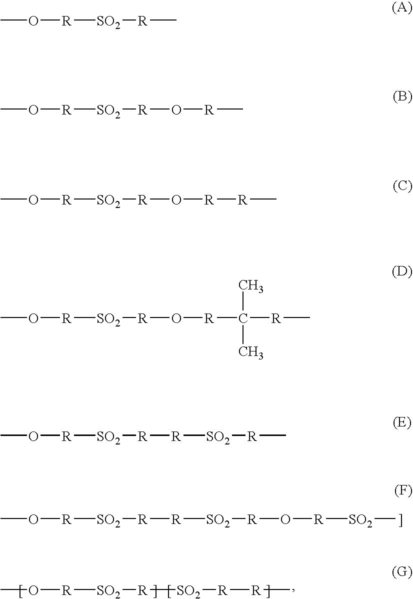

wherein the radicals R, independently of another, identical or different, represent aromatic or heteroaromatic groups, these radicals having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the context of the present invention include homopolymers and copolymers, for example random copolymers. Particularly preferred polysulphones comprise recurring units of the formulae H to N:

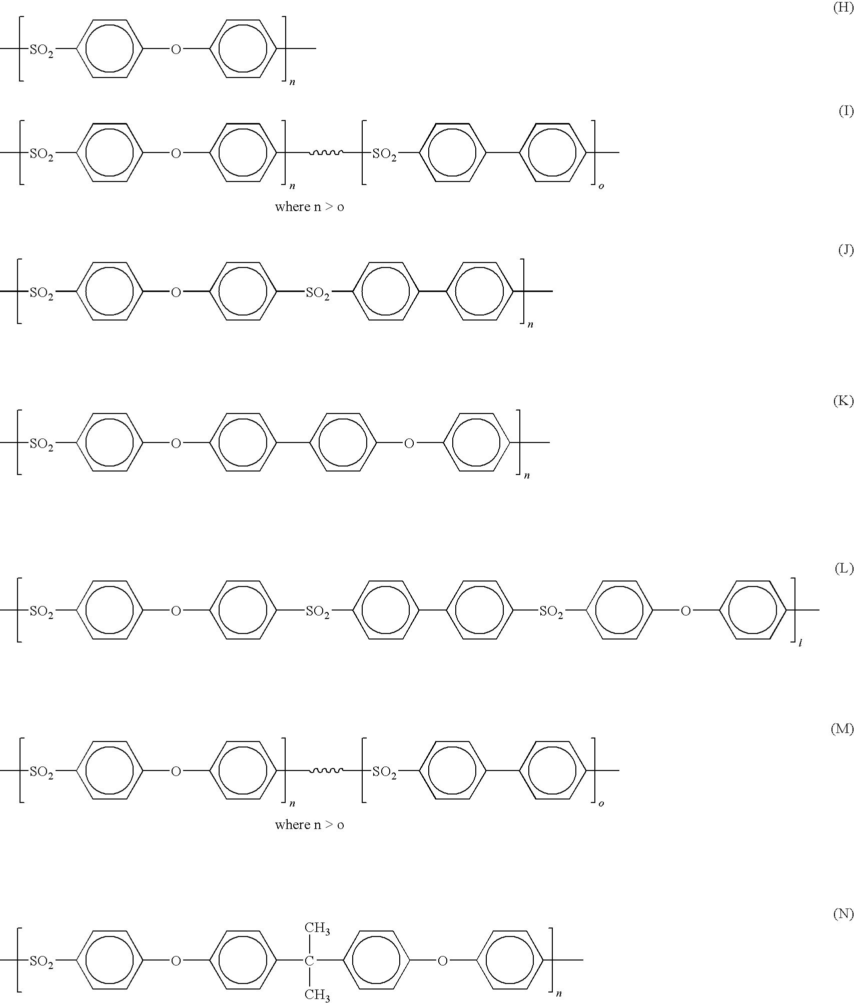

The previously described polysulphones can be obtained commercially under the trade names ®Victrex 200 P, ®Victrex 720 P, ®Ultrason E, ®Ultrason S, ®Mindel, ®Radel A, ®ORadel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

To produce polymer films, a polymer, preferably a polyazole can be dissolved in an additional step in polar, aprotic solvents such as dimethylacetamide (DMAc) and a film is produced by means of classical methods. In this case, the reinforcing elements are preferably introduced into the film during the film production. In order to remove residues of solvents, the film thus obtained can be treated with a washing liquid as in German patent application DE 101 098 29. Due to the cleaning of the polyazole film to remove residues of solvents described in the German patent application, the mechanical properties of the film are surprisingly improved. These properties include in particular the modulus of elasticity, the tear strength and the break strength of the film.

Additionally, the polymer film can have further modifications, for example by cross-linking, as described in German patent application DE 101 107 52 or in WO 00/44816. In a preferred embodiment, the polymer film used consisting of an alkaline polymer and at least one blend component additionally contains a cross-linking agent, as described in German patent application DE 101 401 47.

The thickness of the polyazole films can be within wide ranges. Preferably, the thickness of the polyazole film before its doping with acid is generally in the range of μm to 2000 μm, particularly preferably in the range of 10 μm to 1000 μm, especially preferably in the range of 20 μm to 1000 μm; however, this should not constitute a limitation.

In order to achieve proton conductivity, these films are doped with an acid. In this context, acids include all known Lewis und Brønsted acids, preferably inorganic Lewis und Brønsted acids.

Furthermore, the application of polyacids is also possible, in particular isopolyacids and heteropolyacids, as well as mixtures of different acids. Here, in the spirit of the invention, heteropolyacids define inorganic polyacids with at least two different central atoms, each formed of weak, polybasic oxygen acids of a metal (preferably Cr, MO, V, W) and a non-metal (preferably As, I, P, Se, Si, Te) as partial mixed anhydrides. These include, amongst others, the 12-phosphomolybdatic acid and the 12-phosphotungstic acid.

The degree of doping can influence the conductivity of the polyazole film. The conductivity increases with an increasing concentration of the doping substance until a maximum value is reached.

According to the invention, the degree of doping is given as mole of acid per mole of repeating unit of the polymer. Within the scope of the present invention, a degree of doping between 3 and 80, conveniently between 5 and 60, in particular between 12 and 60 is preferred.

Particularly preferred doping substances are phosphoric and sulphuric acids, or compounds releasing these acids for example during hydrolysis, respectively. A very particularly preferred doping substance is phosphoric acid (H₃PO₄). Here, highly concentrated acids are generally used. According to a particular aspect of the present invention, the concentration of the phosphoric acid is at least 50% by weight, particularly at least 80% by weight, based on the weight of the doping substance.

According to the present invention, the polymer electrolyte membrane has reinforcing elements which penetrate the polymer electrolyte membrane at least partially, i.e. enter the polymer electrolyte membrane at least partially. Particularly preferably, the reinforcing elements are predominantly embedded in the membrane and only protrude sporadically from the membrane, if at all. The membranes reinforced according to the invention can no longer be delaminated in a non-destructive manner.

These are to be distinguished from laminar structures in which the polymer electrolyte membrane and the reinforcing elements each form separate layers which, though connected with one another, do not penetrate each other. Such laminar structures are not encompassed by the scope of the present invention, the present invention only encompasses such reinforced polymer electrolyte membranes in which the reinforcing elements are at least partially connected with the membrane. A partial composite is considered to be a composite of reinforcing element and membrane in which the reinforcing elements conveniently absorb such a force that the reference force of the polymer electrolyte membrane with reinforcing elements, in comparison to the polymer electrolyte membrane without reinforcing elements, differs in a force-elongation diagram at 20° C. within an elongation range of between 0 and 1% in at least one place by at least 10%, preferably by at least 20% and very particularly preferably by at least 30%.

According to the invention, the polymer electrolyte membrane is preferably fibre-reinforced and the reinforcing elements preferably comprise monofilaments, multifilaments, long and/or short fibres, hybrid yarns and/or conjugate fibres. In addition to a reinforcing element made of concrete fibres, the reinforcing element can also be formed by a textile surface. Suitable textile surfaces are non-woven fabrics, woven fabrics, knit fabrics, knitwear, felts, scrims and/or mesh fabrics, particularly preferably scrims, knit fabrics and/or non-woven fabrics. Non-limiting examples of the above-mentioned woven fabrics are those made of poly(acryl), poly(ethyleneterephtalate), poly(propylene), poly(tetrafluoroethylene), poly(ethylene-co-tetrafluoroethylene) (ETFE), 1:1-alternating copolymer of ethylene and chlorotrifluoroethylene (E-CTFE), polyvinylidene fluoride (PVDF), poly(acrylonitrile) as well as polyphenylenesulphide (PPS).

Woven fabrics relate to products made of threads predominantly interlaced at right angles and from monofils and/or multifilament threads. The mesh size of the textile surface can usually be 20 to 2000 μm, textile surfaces, in particular woven fabrics, scrims and mesh fabrics, with a mesh size in the range of 30 to 3000 μm have proven to be particularly advantageous for the purposes of the present invention. In this connection, the mesh size can be determined by an electronic image analysis of an optical or TEM photograph, for example.

The open screen surface a₀ of the textile surface, in particular of the woven fabric, scrim and mesh fabric can usually be in the range of 0.1 to 98%, preferably in the range of 20 to 80% It can be determined by means of the relationship

$${a}_{0} [ \% ] = \frac{{( w )}^{2} \times 100}{{( w + d )}^{2}}$$

where d refers to the yarn diameter and w refers to the mesh size.

The mesh fineness n of the woven fabric can usually be in the range of 8 to 140 n/cm, but preferably in the range of 50 to 90 n/cm. It can be determined by means of the relationship

$$n \text{/} cm = \frac{10000}{( w + d )}$$

The scrims/mesh fabrics usually have 7 to 140 thread counts/cm.

The yarn diameter of the yarns or fibres forming the textile surface, in particular the woven fabric can be in the range of 30-950 μm, but preferably in the range of 30 to 500 μm. It can be determined by an electronic image analysis of an optical or TEM photograph. The minimum thickness of the reinforcing elements preferably matches the total thickness of the polymer membrane.

Woven fabrics very particularly suited for the purposes of the present invention are available from the company SEFAR under the names SEFAR NITEX®, SEFAR PETEX®, SEFAR PROPYLTEX®, SEFAR FLUORTEX® and SEFAR PEAKTEX®, for example.

Non-woven fabrics relate to flexible, porous area-measured materials which are not produced by means of classical methods of fabric bonding with warps and wefts or by mesh forming, but by interlacing and/or cohesive and/or adhesive bonding of fibres (e.g. spunbound or melt-blown non-wovens). Non-woven fabrics are loose materials made of spinnable fibres or filaments, the cohesion of Which generally being brought about by the inherent adhesion of the fibres or by a subsequent mechanical solidification.

According to the invention, the individual fibres can have a preferred direction (oriented or crossed non-woven fabrics) or unoriented (random oriented non-woven fabrics). The non-woven fabrics can be solidified by needling, meshing or intermingling by means of water jets (so-called spunlaced non-woven fabrics) hydrodynamically and/or mechanically.

Adhesively solidified non-woven fabrics are preferably obtained by conglutinating the fibres with liquid binders, in particular with acrylate polymers, SBR/NBR, polyvinyl ester or polyurethane dispersions, or by melting or dissolving so-called binding fibres which were admixed with the non-woven during production.

In a cohesive solidification process, the fibre surfaces are conveniently partially dissolved by means of suitable chemicals and bound by means of pressure or bonded at increased temperatures.

Within the scope of a particularly preferred embodiment of the present invention, the non-woven fabrics are further reinforced with additional threads, woven fabrics or knitwear.

The weight per unit area of the non-woven fabrics is conveniently 30 g/m² to 500 g/m², in particular 30 g/m² to 150 g/m².

Non-limiting examples of particularly preferred non-woven fabrics are SEFAR PETEX©, SEFAR FLUORTEX©, SEFRA PEEKTEX©.

The composition of the reinforcing elements can in principle be chosen freely and be adapted to the concrete application. However, the reinforcing elements conveniently contain glass fibres, mineral fibres, natural fibres, carbon fibres, boron fibres, synthetic fibres, polymer fibres and/or ceramic fibres, in particular SEFAR CARBOTEX©, SEFAR PETEX©, SEFAR FLUORTEX©, SEFRA PEEKTEX©, SEFAR TETEX MONO©, SEFAR TETEX DLW, SEFAR TETEX Multi from the company SEFAR, but also DUOFIL©, EMMITEX yarn©. Also possible are reinforcing elements which have been produced from acid-resistant, corrosion-resistant materials such as, e.g., Hastelloy or similar materials, as well as square-mesh, braided, twill mesh or multiplex fabrics from the company GDK.

In principle; any type and material is suitable as long as it is inert to a large degree under the prevalent conditions in operation in a fuel cell and meets the mechanical requirements of the reinforcement.

The reinforcing elements which are optionally part of a woven fabric, knitwear or non-woven fabric can have a practically round cross-section or also have other forms, such as dumbbell-shaped, kidney-shaped, triangular or multilobal cross-sections. Conjugate fibres are also possible.

The reinforcing elements preferably have a maximum diameter in the range of 10 μm to 500 μm, preferably in the range of 20 μm to 300 μm, particularly preferably in the range of 20 μm to 200 μm and in particular in the range of 25 μm to 100 μm. In this connection, the maximum diameter relates to the largest cross-sectional dimension.

Furthermore, the reinforcing elements conveniently have a Young's modulus of at least 5 GPa, preferably at least 10 GPa, particularly preferably at least 20 GPa. The elongation at break of the reinforcing elements is preferably in the range of 0.6% to 100%, preferably in the range of 1% to 60%.

The proportion by volume of the reinforcing elements, based on the total weight of the polymer electrolyte membrane, is conveniently in the range of 5% by volume to 95% by volume, preferably in the range of 10% by volume to 80% by volume, particularly preferably in the range of 10% by volume to 50% by volume and in particular in the range of 10% by volume to 30% by volume. It is preferably measured at 20° C.

Within the scope of the present invention, the reinforcing elements conveniently absorb such a force that the reference force of the polymer electrolyte membrane with reinforcing elements, in comparison to the polymer electrolyte membrane without reinforcing elements, differs in a force-elongation diagram at 20° C. within an elongation range of between 0 and 1% in at least one place by at least 10%, preferably by at least 20% and very particularly preferably by at least 30%.

Furthermore, the reinforcement is conveniently such that the reference force of the polymer electrolyte membrane at room temperature (20° C.), divided by the reference force of the support insert at 180° C., measured in at least one point within an elongation range of between 0 and 1%, results in a ratio of at most 3, preferably at most 2.5, particularly preferably less than 2.

The measurement of the reference force is performed according to EN 29073, part 3, on specimens with a width of 5 cm and a measurement length of 100 mm. The numerical value of the preload force, expressed in centinewton [cN], here matches the numerical value of the mass per unit area of the specimen, expressed in gram per square metre.

The polymer electrolyte membranes can be produced in a manner known per se, conveniently being provided directly during their manufacture with the reinforcing elements, preferably by forming the polymer electrolyte membrane in the presence of the reinforcing elements and placing them in the course of this such that they penetrate the polymer electrolyte membrane at least partially.

In this connection, the proton-conductive membranes are preferably obtained by means of a method comprising the steps of
I) dissolving the polymers, particularly polyazoles in phosphoric acid
II) heating the solution obtainable in accordance with step I) under inert gas to temperatures of up to 400° C.,
III) placing reinforcing elements on a support,
IV) forming a membrane using the solution of the polymer in accordance with step II), optionally after intermittent cooling, on the support from step II) in such a manner that the reinforcing elements penetrate the solution at least partially, and
V) treating the membrane formed in step II) until it is self-supporting.

Such a procedure, however without the insertion of reinforcing elements, is described in DE 102 464 61, for example, from which the person skilled in the art can gather more valuable information regarding steps I), III), IV) and V). The corresponding membranes without reinforcing elements are available under the trade name Celtec®, for example.

Within the scope of another particularly preferred variant of the present invention, doped polyazole films are obtained by a method comprising the steps of
A) mixing one or more aromatic tetramino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) placing reinforcing elements on a support,
C) applying a layer using the mixture in accordance with step A) to the support from step B) in such a manner that the reinforcing elements penetrate the mixture at least partially,
D) heating the flat structure/layer obtainable in accordance with step C) under inert gas to temperatures of up to 350° C., preferably up to 280° C., with formation of the polyazole polymer,
E) treating the membrane formed in step D) (until it is self-supporting).

This variant requires the use of reinforcing elements which have a melting point above the temperatures mentioned in step D).

If reinforcing elements which have a melting point below the temperatures mentioned in step D) are to be used, step D) (heating the mixture from step A)) can also be performed directly after step A). Step C) can be performed after subsequent cooling.

It is furthermore also possible to dispense with step B) and carry out the supply of the reinforcing elements before or during step D). Depending on the nature of the materials, the reinforcing elements can also be supplied via a calender which is optionally heated. In this connection, the reinforcement is pressed into the still ductile base material.

Such a procedure, however without the insertion of reinforcing elements, is described in DE 102 464 59, for example, from which the person skilled in the art can gather more valuable information regarding steps A), C), D) and E). The corresponding membranes without reinforcing elements are available under the trade name Celtec®, for example.

The aromatic or heteroaromatic carboxylic acid compounds to be employed in step A) preferably comprise dicarboxylic acids and tricarboxylic acids and tetracarboxylic acids and their esters or their anhydrides or their acid chlorides. The term aromatic carboxylic acids likewise also comprises heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalsäure, 3,4-cihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)hexafluoropropane, 4,4′-stilbenedicarboxylic acid, 4-carboxycinnamic acid or their C1-C20 alkyl esters or C5-C12 aryl esters, or their acid anhydrides or their acid chlorides.

The aromatic tricarboxylic acids, tetracarboxylic acids or their C1-C20 alkyl esters or C5-C12 aryl esters or their acid anhydrides or their acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or their C1-C20 alkyl esters or C5-C12 aryl esters or their acid anhydrides or their acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids employed are preferably heteroaromatic dicarboxylic acids or tricarboxylic acids or tetracarboxylic acids or their esters or their anhydrides. Heteroaromatic carboxylic acids are understood to mean aromatic systems which contain at least one nitrogen, oxygen, sulphur or phosphorus atom in the aromatic group. These are preferably pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid and their C1-C20 alkyl esters or C5-C12 aryl esters, or their acid anhydrides or their acid chlorides.

The content of tricarboxylic acids or tetracarboxylic acids (based on dicarboxylic acid used) is between 0 and 30 mol/-%, preferably 0.1 and 20 mol/-%, in particular 0.5 and 10 mol/-%.

The aromatic and heteroaromatic diaminocarboxylic acids used are preferably diaminobenzoic acid and its monohydrochloride or dihydrochloride derivatives.

Preferably, mixtures of at least 2 different aromatic carboxylic acids are used. Particularly preferably, mixtures are used which also contain heteroaromatic carboxylic acids additional to aromatic carboxylic acids. The mixing ratio of aromatic carboxylic acids to heteroaromatic carboxylic acids is between 1:99 and 99:1, preferably 1:50 and 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The tetramino compounds to be employed in step A) preferably comprise 3,3′,4,4′-tetraminobiphenyl, 2,3,5,6-tetraminopyridine, 1,2,4,5-tetraminobenzene, 3,3′,4,4′-tetraminodiphenylsulphone, 3,3′,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane as well as their salts, in particular their monohydrochloride, dihydrochloride, trihydrochloride and tetrahydrochloride derivatives.

The polyphosphoric acid used in step A) is a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of polyphosphoric acid to the sum of all monomers of 1:10,000 to 10, 000:1, preferably 1:1000 to 1000:1, in particular 1:100 to 100:1.

The layer formation in accordance with step C) is performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Thus, the viscosity can be adjusted to the desired value and the formation of the membrane be facilitated.

The layer produced in accordance with step C) has a thickness of between 20 and 4000 μm, preferably of between 30 and 3500 μm, in particular of between 50 and 3000 μm.

If the mixture in accordance with step A) also contains tricarboxylic acids or tetracarboxylic acid, branching/cross-linking of the formed polymer is achieved therewith. This contributes to an improvement in the mechanical property.

Treatment of the polymer layer produced in accordance with step D) in the presence of moisture at temperatures and for a sufficient period of time until the layer exhibits a sufficient strength for use in fuel cells. The treatment can be effected to the extent that the membrane is self-supporting so that it can be detached from the support without any damage.

In accordance with step D), the flat structure obtained in step C) is heated to a temperature of up to 350° C., preferably up to 280° C. and particularly preferably in the range of 200° C. to 250° C. The inert gases to be employed in step D) are known to those in professional circles. These include in particular nitrogen as well as noble gases, such as neon, argon, helium.

In a variant of the method, the formation of oligomers and polymers can already be brought about by heating the mixture resulting from step A) to temperatures of up to 350° C., preferably up to 280° C. Depending on the selected temperature and period of time, it is then possible to dispense partly or fully with the heating in step D). This variant is also an object of the present invention.

The treatment of the membrane in step E) is performed at temperatures of more than 0° C. and less than 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the polyphosphoric acid present contributes to the solidification of the membrane by means of partial hydrolysis with formation of low molecular weight polyphosphoric acid and/or phosphoric acid.

The partial hydrolysis of the polyphosphoric acid in step E) leads to a solidification of the membrane and a reduction in the layer thickness and the formation of a membrane having a thickness of between 15 and 3000 μm, preferably between 20 and 2000 μm, in particular between 20 and 1500 μm, which is self-supporting.

The intramolecular and intermolecular structures (interpenetrating networks IPN) present in the polyphosphoric acid layer in accordance with step C) lead to an ordered membrane formation in step C), which is responsible for the particular properties of the membrane formed.

The upper temperature limit for the treatment in accordance with step E) is typically 150° C. With extremely short action of moisture, for example from overheated steam, this steam can also be hotter than 150° C. The duration of the treatment is substantial for the upper limit of the temperature.

The partial hydrolysis (step E) can also take place in climatic chambers where the hydrolysis can be specifically controlled with defined moisture action. In this connection, the moisture can be specifically set via the temperature or saturation of the surrounding area in contact with it, for example gases such as air, nitrogen, carbon dioxide or other suitable gases, or steam. The duration of the treatment depends on the parameters chosen as aforesaid.

Furthermore, the duration of the treatment depends on the thickness of the membrane.

Typically, the duration of the treatment amounts to between a few seconds to minutes, for example with the action of overheated steam, or up to whole days, for example in the open air at room temperature and lower relative humidity. Preferably, the duration of the treatment is between 10 seconds and 300 hours, in particular 1 minute to 200 hours.

If the partial hydrolysis is performed at room temperature (20° C.) with ambient air having a relative humidity of 40-80%, the duration of the treatment is between 1 and 200 hours.

The membrane obtained in accordance with step E) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Membranes with a particularly high concentration of phosphoric acid can be obtained by the method comprising the steps A) to E). A concentration of 10 to 50 (mole of phosphoric acid, based on one repeating unit of formula (I), for example polybenzimidazole), particularly between 12 and 40 is preferred. Only with very much difficulty or not at all is it possible to obtain such high degrees of doping (concentrations) by doping polyazoles with commercially available orthophosphoric acid.

An advantageous variation of the method described above in which doped polyazole films can be produced by using polyphosphoric acid comprises the steps of
1) reacting one or more aromatic tetramino compounds with one or more aromatic carboxylic acids or esters thereof which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) in polyphosphoric acid,
3) heating the solution obtainable in accordance with step 2) under inert gas to temperatures of up to 300° C., preferably up to 280° C., with formation of the dissolved polyazole polymer,
4) placing reinforcing elements on a support,
5) forming a membrane using the solution of the polyazole polymer in accordance with step 3) on the support from step 4) in such a manner that the reinforcing elements penetrate the solution at least partially, and
6) treating the membrane formed in step 5) until it is self-supporting.

The steps of the method described under items 1) to 6) have been explained before in detail for the steps A) to E), where reference is made thereto, in particular with regard to preferred embodiments.

Such a procedure, however without the insertion of reinforcing elements, is furthermore described in DE 102 464 59, for example, from which the person skilled in the art can gather more valuable information regarding steps 1)-3) and 5) and 6). The corresponding membranes without reinforcing elements are available under the trade name Celtec®, for example.

In another preferred embodiment of the present invention, monomers comprising phosphonic acid groups and/or monomers comprising sulphonic acid groups are employed for the production of the polymer electrolyte membranes. Particularly convenient embodiments of this variant comprise the steps of
A) producing a mixture comprising monomers comprising phosphonic acid groups and at least one polymer,
B) placing reinforcing elements on a support,
C) applying a layer using the mixture in accordance with step A) to the support from step B) in such a manner that the reinforcing elements penetrate the mixture at least partially,
D) polymerising the monomers comprising phosphonic acid groups present in the flat structure obtainable in accordance with step C).

Within the scope of yet another particularly preferred variant of the present invention, doped polyazole films are obtained by a method comprising the steps of
A) dissolving the polyazol-polymer in organic phosphonic anhydrides with formation of a solution and/or dispersion,
B) heating the solution from step A) under inert gas to temperatures of up to 400° C., preferably up to 350° C., particularly of up to 300° C.,
C) placing reinforcing elements on a support,
D) forming a membrane using the solution of the polyazole polymer from step B) on the support from step C), and
E) treating the membrane formed in step D) until it is self-supporting.

Such a procedure, however without the insertion of reinforcing elements, is described in WO 2005/063851, for example, from which the person skilled in the art can gather more valuable information regarding steps A), B), D) and E). The corresponding membranes without reinforcing elements are available under the trade name CeLtec®, for example.

The organic phosphonic anhydrides used in step A) are cyclic compounds of the formula

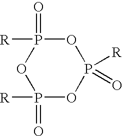

or linear compounds of the formula

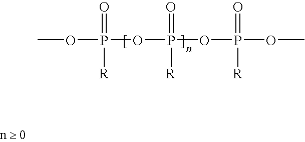

or anhydrides of the multiple organic phosphonic acids, such as of the formula of anhydrides of the diphosphonic acid

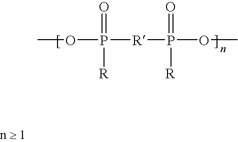

wherein the radicals R and R′ are identical or different and represent a C₁-C₂₀ carbon-containing group.

Within the scope of the present invention, a C₁-C₂₀ carbon-containing group is understood to mean preferably the radicals C₁-C₂₀ alkyl, particularly preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₂₀ alkenyl, particularly preferably ethenyl, propenyl, butenyl, pentenyl, cyclopentenyl, hexenyl, cyclohexenyl, octenyl or cyclooctenyl, C₁-C₂₀ alkynyl, particular preferably ethynyl, propynyl, butynyl, pentynyl, hexynyl or octynyl, C₆-C₂₀ aryl, particularly preferably phenyl, biphenyl, naphthyl or anthracenyl, C₁-C₂₀ fluoroalkyl, particularly preferably trifluoromethyl, pentafluoroethyl or 2,2,2-trifluoroethyl, C₆-C₂₀ aryl, particularly preferably phenyl, biphenyl, naphthyl, anthracenyl, triphenylenyl, [1,1′;3′,1″]-terphenyl-2′-yl, binaphthyl or phenanthrenyl, C₆-C₂₀ fluoroaryl, particularly preferably tetrafluorophenyl or heptafluoronaphthyl, C₁-C₂₀ alkoxy, particularly preferably methoxy, ethoxy, n-propoxy, i-propoxy, n-butoxy, i-butoxy, s-butoxy or t-butoxy, C₆-C₂₀ aryloxy, particularly preferably phenoxy, naphthoxy, biphenyloxy, anthracenyloxy, phenanthrenyloxy, C₇-C₂₀ arylalkyl, particularly preferably phenoxy, naphthoxy, biphenyloxy, anthracenyloxy, phenanthrenyloxy, C₇-C₂₀ arylalkyl, particularly preferably o-tolyl, m-tolyl, p-tolyl, 2,6-dimethylphenyl, 2,6-diethylphenyl, 2,6-di-1-propylphenyl, 2,6-di-t-butylphenyl, o-t-butylphenyl, m-t-butylphenyl, p-t-butylphenyl, C₇-C₂₀ alkylaryl, particularly preferably benzyl, ethylphenyl, propylphenyl, diphenylmethyl, triphenylmethyl or naphthalenylmethyl, C₇-C₂₀ aryloxyalkyl, particularly preferably o-methoxyphenyl, m-phenoxymethyl, p-phenoxymethyl, C₁₂-C₂₀ aryloxyaryl, particularly preferably p-phenoxyphenyl, C₅-C₂₀ heteroaryl, particularly preferably 2-pyridyl, 3-pyridyl, 4-pyridyl, quinolinyl, isoquinolinyl, acridinyl, benzoquinolinyl or benzoisoquinolinyl, C₄-C₂₀ heterocycloalkyl, particularly preferably furyl, benzofuryl, 2-pyrrolidinyl, 2-indolyl, 3-indolyl, 2,3-dihydroindolyl, C₈-C₂₀ arylalkenyl, particularly preferably o-vinylphenyl, m-vinylphenyl, p-vinylphenyl, C₈-C₂₀ arylalkynyl, particularly preferably o-ethynylphenyl, m-ethynylphenyl or p-ethynylphenyl, C₂-C₂₀ heteroatom-containing group, particularly preferably carbonyl, benzoyl, oxybenzoyl, benzoyloxy, acetyl, acetoxy or nitril, where one or more C₁-C₂₀ carbon-containing groups can form a cyclic system.

In the above-mentioned C₁-C₂₀ carbon-containing groups, one or more CH₂ groups that are not adjacent to each other can be replaced by —O—, —S—, —NR¹— or —CONR²— and one or more H atoms can be replaced by F.

In the above-mentioned C₁-C₂₀ carbon-containing groups which can include the aromatic systems, one or more CH groups that are not adjacent to each other can be replaced by —O—, —S—, —NR¹— or —CONR²— and one or more H atoms can be replaced by F.

The radicals R¹ and R² are identical or different at each occurrence of H or are an aliphatic or aromatic hydrocarbon radical having 1 to 20 C atoms.

Particularly preferred are organic phosphonic anhydrides which are partially fluorinated or perfluorinated.

The organic phosphonic anhydrides used in step A) can also be employed in combination with polyphosphoric acid and/or P₂O₅. The polyphosphoric acids are customary polyphosphoric acids as they are available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The organic phosphonic anhydrides used in step A) can also be employed in combination with single or multiple organic phosphonic acids.

The single and/or multiple organic phosphonic acids are compounds of the formula

R—PO₃H₂

H₂O₃P—R—PO₃H₂

RPO₃H₂]ₙ

wherein the radicals R are identical or different and represent a C₁-C₂₀ carbon-containing group and n>2. Particularly preferred radicals R were already described above.

The organic phosphonic acids used in step A) are commercially available, for example the products from the company Clariant or Aldrich.

The organic phosphonic acids used in step A) comprise no vinyl-containing phosphonic acids as are described in the German patent application No. 10213540.1.

The mixture produced in step A) has a weight ratio of organic phosphonic anhydrides to the sum of all polymers of 1:10,000 to 10,000:1, preferably 1:1000 to 1000:1, in particular 1:100 to 100:1. If these phosphonic anhydrides are used in a mixture with polyphosphoric acid or single and/or multiple organic phosphonic acids, these have to be considered in the phosphonic anhydrides.

In addition, further organophosphonic acids, preferably perfluorinated organic phosphonic acids can be added to the mixture produced in step A). This addition can take place before and/or during step B) resp. before step C). Through this, it is possible to control the viscosity.

The steps of the method described under items B) to E) have been explained before in detail, where reference is made thereto, in particular with regard to preferred embodiments.

The membrane, particularly the membrane based on polyazoles, can further be cross-linked at the surface by action of heat in the presence of atmospheric oxygen. This hardening of the membrane surface further improves the properties of the membrane. To this end, the membrane can be heated to a temperature of at least 150° C., preferably at least 200° C. and particularly preferably at least 250° C. In this step of the method, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively. Another method is β-ray irradiation. In this connection, the irradiation dose is between 5 and 200 kGy.

Depending on the degree of cross-linking desired, the duration of the cross-linking reaction can be within a wide range. In general, this reaction time lies in the range of 1 second to 10 hours, preferably 1 minute to 1 hour; however, this should not constitute a limitation.

The production of the reinforced polymer electrolyte membranes can take place in a manner known per se. The introduction of the reinforcing elements into a free-flowing or at least still ductile polymer mass and/or monomer or oligomer composition, preferably a polymer melt, polymer solution, polymer dispersion or polymer suspension and the subsequent solidification of the polymer composition, for example by cooling or removing volatile components (solvents) and/or chemical reaction (e.g. cross-linking or polymerisation) are particularly preferred.

According to the invention, the membrane electrode assembly comprises at least two electrochemically active electrodes (anode and cathode) which are separated by the polymer electrolyte membrane. The term “electrochemically active” indicates that the electrodes are capable to catalyse the oxidation of hydrogen and/or at least one reformate and the reduction of oxygen. This property can be obtained by coating the electrodes with platinum and/or ruthenium. The term “electrode” means that the material is electrically conductive. The electrode can optionally include a precious-metal layer. Such electrodes are known and are described in U.S. Pat. No. 4,191,618, U.S. Pat. No. 4,212,714 and U.S. Pat. No. 4,333,805, for example.

The electrodes preferably comprise gas diffusion layers, which are in contact with a catalyst layer.

Flat, electrically conductive and acid-resistant structures are commonly used as gas diffusion layers. These include, for example, graphite-fibre paper, carbon-fibre paper, graphite fabric and/or paper which was rendered conductive by addition of carbon black. Through these layers, a fine distribution of the flows of gas and/or liquid is achieved.

Furthermore, it is also possible to use gas diffusion layers which contain a mechanically stable stabilizing material which is impregnated with at least one electrically conductive material, e.g., carbon (for example carbon black). Particularly suitable stabilizing materials for these purposes comprise fibres, for example in the form of non-woven fabrics, paper or fabrics, in particular carbon fibres, glass fibres or fibres containing organic polymers, for example polypropylene, polyester (polyethylene terephthalate), polyphenylenesulphide or polyether ketones. Further details of such diffusion layers can be found in WO 9720358, for example.

The gas diffusion layers preferably have a thickness in the range of 80 μm to 2000 μm, in particular in the range of 100 μm to 1000 μm and particularly preferably in the range of 150 μm to 500 μm.

Furthermore, the gas diffusion layers conveniently have a high porosity. This is preferably in the range of 20% to 80%.

The gas diffusion layers can contain customary additives. These include, amongst others, fluoropolymers, such as, e.g., polytetrafluoroethylene (PTFE) and surface-active substances.

According to a particular embodiment, at least one of the gas diffusion layers can consist of a compressible material. Within the context of the present invention, a compressible material is characterized by the property that the gas diffusion layer can be compressed to half, in particular a third of its original thickness without losing its integrity.

This property is generally exhibited by gas diffusion layers made of graphite fabric and/or paper which was rendered conductive by addition of carbon black.

The catalytically active layer contains a catalytically active substance. This includes, amongst others, noble metals, in particular platinum, palladium, rhodium, iridium and/or ruthenium. These substances can also be employed in the form of alloys with each other. Furthermore, these substances can also be used in an alloy with non-noble metals, such as, for example, Cr, Zr, Ni, Co and/or Ti. In addition, the oxides of the above-mentioned noble metals and/or non-noble metals can also be employed. The above-mentioned metals are usually employed according to known methods in the form of nanoparticles on a support material, in most cases carbon with a highly specific surface.

According to a particular aspect of the present invention, the catalytically active compounds, i.e. the catalysts are used in the form of particles which preferably are sized in the range of 1 to 1000 nm, in particular 5 to 200 nm and preferably 10 to 100 nm.

According to a particular embodiment of the present invention, the weight ratio of fluoropolymer to catalyst material comprising at least one precious metal and optionally one or more support materials is greater than 0.05, this ratio preferably lying within the range of 0.1 to 0.6. According to a particular embodiment of the present invention, the catalyst layer has a thickness in the range of 1 to 1000 μm, in particular from 5 to 500 μm, preferably from 10 to 300 μm. This value represents a mean value, which can be determined by averaging the measurements of the layer thickness from photographs that can be obtained with a scanning electron microscope (SEM).

According to a particular embodiment of the present invention, the content of noble metals of the catalyst layer is 0.1 to 10.0 mg/cm², preferably 0.2 to 6.0 mg/cm² and particularly preferably 0.2 to 3.0 mg/cm². These values can be determined by elemental analysis of a flat sample.

The catalyst layer is in general not self-supporting but is usually applied to the gas diffusion layer and/or the membrane. In this connection, part of the catalyst layer can, for example, diffuse into the gas diffusion layer and/or the membrane, resulting in the formation of transition layers. This can also lead to the catalyst layer being understood as part of the gas diffusion layer.

According to the invention, the surfaces of the polymer electrolyte membranes are in contact with the electrodes such that the first electrode covers the front of the polymer electrolyte membrane and the electrode covers the back of the polymer electrolyte membrane, in each case partially or completely, preferably only partially. In this connection, the front and the back of the polymer electrolyte membrane relate to the side of the polymer electrolyte membrane facing the viewer and the side of the polymer electrolyte membrane facing away from the viewer, respectively, the direction of view being from the first electrode (front), preferably the cathode towards the second electrode (back), preferably the anode.

For further information on polymer electrolyte membranes and electrodes suitable according to the invention, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned references with respect to the structure and production of membrane electrode assemblies as well as the electrodes, gas diffusion layers and catalysts to be chosen is also part of the description.

The production of the membrane electrode assembly according to the invention is apparent to the person skilled in the art. Generally, the different components of the membrane electrode assembly are superposed and connected with each other by means of pressure and temperature, the laminating usually taking place at a temperature in the range of 10 to 300° C., in particular 20° C. to 200° C. and at a pressure in the range of 1 to 1000 bar, in particular from 3 to 300 bar.

As the performance of an individual fuel cell is often too low for many applications, within the scope of the present invention, preferably several individual fuel cells are joined by means of separator plates to form one fuel cell (fuel cell stack). In doing so, the separator plates should seal the gas spaces of the cathode and the anode against the exterior and between the gas spaces of the cathode and the anode, optionally in combination with further sealing materials. To this end, the separator plates are preferably applied to the membrane electrode assembly in a sealing manner. In this connection, the sealing effect can be increased further by pressing the composite of separator plates and membrane electrode assembly together.

The separator plates preferably each include at least one gas duct for reaction gases which are conveniently placed on the side facing the electrodes. The gas ducts are supposed to allow for the distribution of the reactant fluids.

Particularly surprising, it was found that the membrane electrode assemblies according to the invention are characterized by a markedly improved mechanical stability and strength and can thus be used for the production of fuel cell stacks with a particularly high performance. Here, the previously usual fluctuations in performance of the resulting fuel cell stacks are no longer observed and a hitherto unknown quality, reliability and reproducibility are achieved.

Due to their dimensional stability at varying ambient temperatures and humidity, the membrane electrode assemblies according to the invention can be stored or shipped without any problems. Even after prolonged storage or after shipping to locations with markedly different climatic conditions, the dimensions of the membrane electrode assemblies are correct to be inserted into fuel cell stacks without difficulty. In this case, the membrane electrode assembly need not be conditioned for an external assembly on site which simplifies the production of the fuel cell and saves time and cost.

++One benefit of preferred membrane electrode assemblies is that they allow for the operation of the fuel cell at temperatures above 120° C. This applies to gaseous and liquid fuels, such as, e.g., hydrogen-containing gases that are produced from hydrocarbons in an upstream reforming step, for example. In this connection, e.g. oxygen or air can be used as oxidant.

Another benefit of preferred membrane electrode assemblies is that, during operation at more than 120° C., they have a high tolerance to carbon monoxide, even with pure platinum catalysts, i.e. without any further alloy components. At temperatures of 160° C., e.g., more than 1% of CO can be contained in the fuel gas without this leading to a remarkable reduction in performance of the fuel cell.

Preferred membrane electrode assemblies can be operated in fuel cells without the need to humidify the fuels and the oxidants despite the high operating temperatures possible. The fuel cell nevertheless operates in a stable manner and the membrane does not lose its conductivity. This simplifies the entire fuel cell system and results in additional cost savings as the guidance of the water circulation is simplified. Furthermore, the behaviour of the fuel cell system at temperatures of less than 0° C. is also improved through this.

Preferred membrane electrode assemblies surprisingly make it possible to cool the fuel cell to room temperature and lower without difficulty and subsequently put it back into operation without a loss in performance. In contrast, conventional fuel cells based on phosphoric acid sometimes also have to be held at a temperature above 40° C. when the fuel cell system is switched off in order to avoid irreversible damages.

Furthermore, the preferred membrane electrode assemblies of the present invention exhibit a very high long-term stability. It was found that a fuel cell according to the invention can be continuously operated over long periods of time, e.g. more than 5000 hours, at temperatures of more than 120° C. with dry reaction gases without it being possible to detect an appreciable degradation in performance. The power densities obtainable in this connection are very high, even after such a long period of time.

In this connection, the fuel cells according to the invention exhibit, even after a long period of time, for example more than 5000 hours, a high open circuit voltage which after this period of time is preferably at least 900 mV. To measure the open circuit voltage, a fuel cell with a hydrogen flow on the anode and an air flow on the cathode is operated currentless. The measurement is carried out by switching the fuel cell from a current of 0.2 A/cm² to the currentless state and then recording the open circuit voltage for 5 minutes from this point onwards. The value after 5 minutes is the respective open circuit potential. The measured values of the open circuit voltage apply to a temperature of 160° C. Furthermore, the fuel cell preferably exhibits a low gas cross over after this period of time. To measure the cross over, the anode side of the fuel cell is operated with hydrogen (5 l/h), the cathode with nitrogen (5 l/h). The anode serves as the reference and counter electrode, the cathode as the working electrode. The cathode is set to a potential of 0.5 V and the hydrogen diffusing through the membrane and whose mass transfer is limited at the cathode oxidizes. The resulting current is a variable of the hydrogen permeation rate. The current is <3 mA/cm², preferably <2 mA/cm², particularly preferably <1 mA/cm² in a cell of 50 cm². The measured values of the H₂ cross over apply to a temperature of 160° C.

Furthermore, the membrane electrode assemblies according to the invention are characterized by an improved temperature and corrosion resistance and a relatively low gas permeability, in particular at high temperatures. According to the invention, a decline of the mechanical stability and the structural integrity, in particular at high temperatures, is avoided as good as possible.

Furthermore, the membrane electrode assemblies can be produced in an inexpensive and simple manner.

For further information on membrane electrode assemblies, reference is made to the technical literature, in particular the patents U.S. Pat. No. 4,191,618, U.S. Pat. No. 4,212,714 and U.S. Pat. No. 4,333,805. The disclosure contained in the above-mentioned citations [U.S. Pat. No. 4,191,618, U.S. Pat. No. 4,212,714 and U.S. Pat. No. 4,333,805] with respect to the structure and production of membrane electrode assemblies as well as the electrodes, gas diffusion layers and catalysts to be chosen is also part of the description.

### EXAMPLE

### Membrane Electrode Assembly A

### Reference

Anode: The anode catalyst is Pt on a carbon support.

Cathode: The cathode catalyst is a Pt alloy on a carbon support.

Membrane A: A polymer membrane doped with phosphoric acid serves as the membrane, the polymer of the membrane consisting of para-polybenzimidazole.

### Membrane Electrode Assembly B

Anode: The anode catalyst is Pt on a carbon support.

Cathode: The cathode catalyst is a Pt alloy on a carbon support.

Membrane A: A polymer membrane doped with phosphoric acid serves as the membrane, the polymer of the membrane consisting of para-polybenzimidazole. The membrane was applied to both sides of a non-woven made of polyether ether ketone (Sefar Peektex®) in a thickness of 50 μm.

### Experiment:

Both membrane electrode assemblies were continuously operated in fuel cells with an active surface area of 50 cm² at 200° C. for 350 h (anode gas: hydrogen with a stoichiometry of 1.2; cathode gas: air with a stoichiometry of 2) and current-voltage characteristics were recorded during this operation. The voltage-current characteristics are a measure of the performance of the fuel cell. The cell resistance (measurement of impedance of 1 kHz) was measured during the operating time. The change in cell resistance is a measure of the change in electrical contact between membrane electrode assembly and the flow-field plates used. If the thickness of the membrane is reduced in operation, the cell resistance increases.

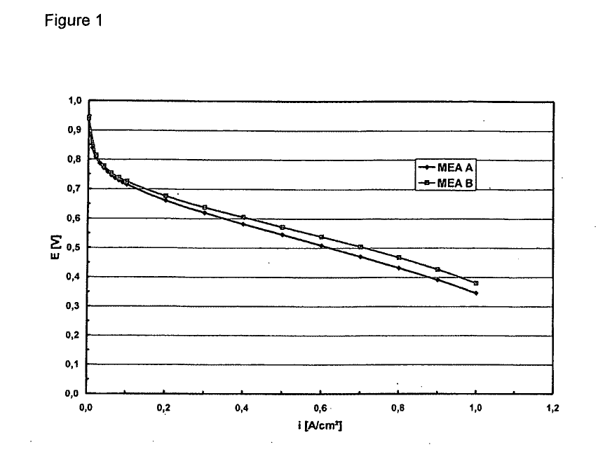

FIG. 1 shows the current-voltage characteristics after 350 h at 200° C.

Table 1 shows the change in cell resistance during operation of membrane electrode assembly A.

Table 2 shows the change in cell resistance during operation of membrane electrode assembly B.

The current-voltage characteristic of membrane electrode assembly A after 350 h lies markedly below the characteristic of membrane electrode assembly B. For example, only the cell voltage of membrane electrode assembly A at a current of 0.5 A/cm² is by 26 mV lower than the cell voltage of membrane electrode assembly B.

It can be seen from table 1 that the resistance of membrane electrode assembly A increases from 2.40 to 3.30 mOhm during operation as the thickness of membrane A is reduced by the action of pressure and temperature, while the resistance of membrane electrode assembly B remains constant over the same period of time as the reinforced membrane B keeps its thickness.

TABLE 1
Membrane electrode assembly A:

| Operating time [h] | Cell resistance |
|---|---|
| 60 h | 2.30 mOhm |
| 200 h | 2.90 mOhm |
| 350 h | 3.30 mOhm |

TABLE 2
Membrane electrode assembly B:

| Operating time [h] | Cell resistance |
|---|---|
| 60 h | 2.05 mOhm |
| 200 h | 2.05 mOhm |
| 350 h | 2.10 mOhm |

1-18. (canceled)

19. A membrane electrode assembly comprising at least two electrochemically active electrodes which are separated by at least on polymer electrolyte membrane, wherein the polymer electrolyte membrane has reinforcing elements which at least partially penetrate the polymer electrolyte membrane.

20. The membrane electrode assembly according to claim 19, wherein the polymer electrolyte membrane is fiber-reinforced.

21. The membrane electrode assembly according to claim 20, wherein the reinforcing elements comprise a monofilament, a multifilament, a short fiber, a long fiber, a non-woven fabric, a woven fabric, a knitted fabric, a knitwear or a mixture thereof.

22. The membrane electrode assembly according to claim 20, wherein the reinforcing elements comprise a glass fiber, a mineral fiber, a natural fiber, a carbon fiber, a boron fiber, a synthetic fiber, a polymer fiber, a ceramic fiber or a mixture thereof.

23. The membrane electrode assembly according to claim 19, wherein the reinforcing elements have a maximum diameter in the range of 10 μm to 500 μm.

24. The membrane electrode assembly according to claim 19, wherein the reinforcing elements have a Young's modulus of at least 5 GPa

25. The membrane electrode assembly according to claim 19, wherein the reinforcing elements have an elongation at break of 0.5 to 100%.

26. The membrane electrode assembly according to claim 19, wherein the volume proportion of the reinforcing elements, based on the total volume of the polymer electrolyte membrane, is in the range of 5% by volume to 95% by volume.

27. The membrane electrode assembly according to claim 19, wherein the reinforcing elements absorb such a force that the reference force of the polymer electrolyte membrane with reinforcing elements, in comparison to the polymer electrolyte membrane without reinforcing elements, differs in a force-elongation diagram at 20° C. within an elongation range of between 0 and 1% in at least one place by at least 10%.

28. The membrane electrode assembly according to claim 19, wherein the polymer electrolyte membrane comprises a polyazole.

29. The membrane electrode assembly according to claim 28, wherein the polymer electrolyte membrane is doped with phosphoric acid or derivatives derived from phosphoric acid.

30. The membrane electrode assembly according to claim 29, wherein the acid content is between 3 and 50 mole per repeating unit of the polymer.

31. A method for the production of the membrane electrode assembly according to claim 19, wherein
(i) forming a polymer electrolyte membrane in the presence of the reinforcing elements, and
(ii) assembling the membrane and electrodes to form the electrode assembly.

32. The method according to claim 31, wherein the polymer electrolyte membrane is formed by a method comprising the steps of
I) dissolving the polymer, in phosphoric acid
II) heating the solution obtained in accordance with step I) under inert gas to temperatures of up to 400° C.,
III) placing reinforcing elements on a support,
IV) forming a membrane using the solution of the polymer in accordance with step II) on the support from step III) in such a manner that the reinforcing elements penetrate the solution at least partially, and
V) treating the membrane formed in step III) until it is self-supporting.

33. The method according to claim 31, wherein the polymer is a polyazole.

34. The method according to claim 31, wherein the polymer electrolyte membrane is formed by a method comprising the steps of
A) mixing one or more aromatic tetramino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) placing reinforcing elements on a support,
C) applying a layer using the mixture in accordance with step A) to the support from step B) in such a manner that the reinforcing elements penetrate the mixture at least partially,
D) heating the flat structure/layer obtained in accordance with step C) under inert gas to temperatures of up to 350° C., with formation of the polyazole polymer,
E) treating the membrane formed in step D) (until it is self-supporting).

35. The method according to claim 31, wherein the polymer electrolyte membrane is formed by a method comprising the steps of
1) reacting one or more aromatic tetramino compounds with one or more aromatic carboxylic acids or their esters, which contain at least two acid groups per carboxylic acid monomer, or one or more aromatic and/or heteroaromatic diaminocarboxylic acids in the melt at temperatures of up to 350° C.,
2) dissolving the solid prepolymer obtained in accordance with step 1) in polyphosphoric acid,
3) heating the solution obtainable in accordance with step 2) under inert gas to temperatures of up to 300° C., with formation of the dissolved polyazole polymer,
4) placing reinforcing elements on a support,
5) forming a membrane using the solution of the polyazole polymer in accordance with step 3) on the support from step 4) in such a manner that the reinforcing elements penetrate the solution at least partially, and
6) treating the membrane formed in step 5) until it is self-supporting.

36. The method according to claim 31, wherein the polymer electrolyte membrane is formed by a method comprising the steps of
A) producing a mixture comprising monomers comprising phosphonic acid groups and at least one polymer,
B) placing reinforcing elements on a support,
C) applying a layer using the mixture in accordance with step A) to the support from step B) in such a manner that the reinforcing elements penetrate the mixture at least partially,
D) polymerising the monomers comprising phosphonic acid groups present in the flat structure obtainable in accordance with step C).

37. A fuel cell having at least one membrane electrode assembly according to claim 19.
